(19) United States
(12) Patent Application Publication
(10) Pub. No.: US 2005/0143488 A1
(43) Pub. Date: Jun. 30, 2005

(54) Water washable lithographic printing inks having low VOC content

(76) Inventors: Gary F. Dandreaux, Hackensack, NJ (US); Thierry D. Frinault, Romford (GB); David Klein, Wayne, NJ (US); Richard R. Durand JR., Woodridge, NJ (US)

Correspondence Address: Sun Chemical Corporation, 222 Bridge Plaza South, Fort Lee, NJ, 07024, US

(21) Appl. No.: 10/751,164

(22) Filed: Dec. 31, 2003

(51) Int. Cl. C03C 17/00; C09D 11/00

(52) U.S. Cl. 523/160; 524/270; 523/161

(57) ABSTRACT

A water washable lithographic printing ink composition containing a rosin-based resin, an alcohol solvent, a pigment, an acid neutralizing agent, a plasticizer, and a thermoplastic latex emulsion.

### BACKGROUND OF THE INVENTION

1. Field of the Invention

The invention relates to water washable lithographic printing ink compositions having low VOC content.

2. Background of the Art

Typical solvent based inks usually employed in conventional offset lithographic printing processes contain fairly high levels of undesirable VOCs, generally from 30 to 45%, which are flammable and hazardous to the printers who operate the press. Further, the cleaning solutions used for press wash up may also contain volatile organic content (“VOC”).

In order to reduce the level of VOCs in lithographic inks, numerous attempts have been made to the detriment of printing performance and additional required monitoring of components, which is not cost effective.

Canadian patent application CA2,180,057 describes a conventional ink composition which may be washable in water if a small amount of surfactant is added such that the washing solution has a pH of between 8.5 to 13.5. The washing solution must contain a detergent and a surfactant and the pH must be carefully monitored in order for it to be washable without additional solvents and VOCs.

A waterbased, waterfast ink composition is described in WO 95/27759 which include colorant, an aqueous liquid vehicle and a binder composition, which is water soluble and which becomes insoluble in water after drying on a substrate. However, this composition requires use of an aqueous liquid vehicle which is not compatible with offset heatset lithographic printing inks.

WO 96/34923 describes an ink which is washable through an aqueous wash media, wherein the ink comprises at least one component containing free carboxylic acid groups so that the component can be rendered hydrophilic. However, this ink requires an aqueous alkaline wash medium which must be monitored.

Accordingly there is a need for a water washable lithographic ink composition having low VOC content that uses no humectants, which maintains printing performance such as good tack, without causing any scumming or set off at room temperature immediately after printing.

### SUMMARY OF THE INVENTION

It has now been found that the above objectives can be realized by employing a lithographic composition comprised of a rosin-based resin, an alcohol solvent, a pigment, an acid neutralizing agent, a plasticizer, and a latex emulsion.

### DETAILED DESCRIPTION OF THE INVENTION

According to the present invention it has been found that a combination of a rosin-based resin, an alcohol solvent, a pigment, an acid neutralizing agent, a plasticizer, and a latex emulsion provides a composition having excellent tack and dynamic viscosity and gloss profiles for printing.

Rosin-Based Resin

The composition contains a high acid number resin as a binder for the pigments. The high acid number resin may have an acid number of about 20 to about 250. This high acid number rosin assists in water washability of the resulting lithographic ink composition. Suitable rosin-based resins include, but are not limited to, phenolic, maleic, fumaric, pentaerythritol, hydrocarbon resins, and/or mixtures of these groups, rosin resins, rosin salts, tall oil resins, and mixtures thereof.

Suitable resins include those sold under the UNIREZ® mark, available from Arizona Corporation, Jacksonville, Fla., UNITAC® manufactured by Arizona Corporation, Jacksonville, Fla., and JONREZ® manufactured by Mead-Westvaco Corporation, Charleston Heights, S.C. A variety of other conventional rosin resins can be used and are readily known to those of ordinary skill in the art.

Alcohol Solvent

The ink composition contains a mixture of alcohol solvents. The alcohol mixture can contain dodecanol and/or tridecanol. Other suitable solvents include, but are not limited to, glycols, glycolethers, ethanol, propanol, butanol, pentanol, hexanol, heptanol, octanol, nonanol, decanol, undecanol, dodecanol, and mixtures thereof. One of ordinary skill in the art will routinely know to vary the quantity of alcohol in the ink composition in order to achieve the desired tack for a specific ink composition.

Pigment

Pigments which may be incorporated into the composition include all of those conventionally used and any dye, pigment, filler, or the like, which can be bonded to the rosin-based resin and permit the resultant resinated pigment to be dispersed, milled, mixed, blended, or dissolved in any conventional manner in forming the ink composition. The pigment may be in the form of a water-based dispersion, flush, or dry grind.

The pigment may be added to the lithographic printing ink composition in either dry powder, flush, presscake, or water based dispersion form.

Acid Neutralizing Agent

The composition of the present invention also contains an acid neutralization agent. The acid neutralizing agent may also solubilize the high acid number rosin-based resin. Acid neutralizing agents are selected from primary amines, secondary amines and/or tertiary amines such as: monoethanolamine, diethanolamine, triethanolamine, N-dimethylhexylamine, methyldiethanolamine, polyethylene imine, propylene diamine, hexamethylene diamine, dibutyl amine, diethylene triamine, and mixtures thereof. Preferred neutralizing agents include monoethanolamines, and N-methyldiethanolamines. The above neutralizing agents are representative candidates of a variety of neutralizing agents which can be used by those of ordinary skill in the art.

Plasticizer

The waterwashable offset lithographic printing ink of the present invention includes a plasticizer. The plasticizer is selected from the group consisting of tall oil esters, rosin esters, and fatty acid esters. Other suitable plasticizers for use in the ink composition of the invention, include, but are not limited to, alkyds, polyesters, phthallate esters, tallate esters, and mixtures thereof.

Latex Emulsion

Suitable latexes for the present invention include but are not limited to modified styrene acrylics. Other suitable latexes for use in the ink composition of the invention, include, but are not limited to, modified acrylics, modified methacrylics, modified styrenes, modified styrene methacrylics, vinyls and mixtures thereof.

Additives

The water washable lithographic printing inks of the present invention may also incorporate water to act as a rheology and/or surface energy modifier of the ink composition and to enhance the water washability of the ink. The water may be an added component or be contributed by one of the other components of the composition such as residual water from a pigment flush, presscake or latex.

The water washable lithographic printing ink may also include a nonionic surfactant selected from any used routinely in the art for ink and ink-related applications. Examples of suitable nonionic surfactants include acetylenic glycols, ethoxylated glycols, ethoxylated alkylphenols, ethoxylated alcohols, sorbitan esters, and mixtures thereof.

The ink composition may also contain additional additives such as but are not limited to, waxes, for example, Jon Wax 26, Jon Wax 120 (available from S.C. Johnson & Sons, Inc., Racine, Wis., U.S.A.), or Van Wax 35 (available from Vantage, Garfield, N.J., U.S.A.).

The Printing Ink Composition

The printing ink composition is formulated by forming the varnish first through heating the rosin-based resin until molten. The acid neutralizing agent is then added and heated while stirring and until homogeneous. The solvent and plasticizer are added under continued heat and stirring. Once the varnish is homogeneous it is cooled to room temperature. In a separate container, the thermoplastic latex emulsion is added to a pigment dispersion and stirred until homogeneous. The varnish is added to the pigment mixture and stirred until mixed thoroughly.

The water washable lithographic printing ink composition of the present invention contains 0 wt. % to about 40 wt. % of rosin-based resin. It is preferable that the rosin-based resin be present in an amount of up to about 35 wt. % and most preferred that the rosin-based resin be present in an amount of about 15 wt. % to about 25 wt. %. One of ordinary skill in the art will know to vary the amount of rosin-based resin in the ink composition in order to achieve the desired tack and rheology for a specific ink composition.

It is preferred that the alcohol solvent mixture be present of about 0 wt. % to about 35 wt. %, more preferred that the solvent be present from about 0 wt. % to about 15 wt. %, and most preferred that the solvent be present from about 0 wt. % to about 10 wt. %.

It is preferred that the plasticizer be present in the ink composition from about 0 wt. % to about 40 wt. % and more preferred from about 0 wt. % to about 25 wt. %. A person of ordinary skill in the art will recognize that the amount of plasticizer present in the ink composition of the present invention will vary, depending on several factors, including the desired tack and viscosity of the end product.

It is preferred that the thermoplastic latex emulsion be present in the ink composition in the amount of about 0 wt. % to about 40 wt. % and more preferred from about 0 wt. % to about 30 wt. %. A person of ordinary skill in the art will recognize that the amount of thermoplastic latex emulsion present in the ink composition of the present invention will vary, depending on several factors, including the desired hardness of the end product.

The physical characteristics of the ink composition include tack between about 5 to about 25. However, higher or lower tacks are possible. In addition, the print density was in the range of 1.2 to about 1.4, evidencing good printing ink transfer.

The water washable ink composition of the present invention dries at a rate comparable to that achieved by conventional solvent based (high VOC) lithographic printing ink systems, has low tack, emits reduced levels of VOCs, and has a high print density. The inks are as quick drying as conventional solvent based inks while being environmentally safer to produce.

The water washable ink compositions of the present invention are further illustrated by the following non-limiting examples in which all parts and percentages of components are by weight and based on the total weight of the composition, unless otherwise indicated.

### EXAMPLE 1

A water-washable lithographic printing ink was prepared from the components indicated below in Table 1.

TABLE 1

| | Weight |
|---|---|
| Component | Percentage |
| Waterbased pigment dispersion | 23.0 |
| (BCD-9444, Sun Chemical, Ft. | |
| Lee, NJ; 51% cyan pigment) | |
| Modified rosin resin (R891, | 17.3 |
| phenolic modified rosin ester, | |
| manufactured by Resinall) | |
| Acid neutralizing agent | 6.9 |
| (N-methyldiethanolamine) | |
| Solvent (Hexyl Carbitol, diethylene | 11.7 |
| glycol monohexyl ether, Union | |
| Carbide, 5.2%, and Neodol 23, | |
| C12/C13 alcohol blend, Shell, | |
| 6.5%) | |
| Plasticizer (Hercolyn D, methyl | 24.8 |
| ester of rosin, Hercules, 9.0%, and | |
| 2-ethyl hexyl tallate, Chemol, | |
| 15.8%) | |
| Thermoplastic latex emulsion | 12.5 |
| (JONCRYL 89, styrenated acrylic | |
| polymer emulsion, Johnson | |
| Polymer) | |
| Wax (micronized polyethylene) | 3.8 |
| TOTAL | 100.0 |

A varnish was formulated by combining the modified rosin resin with the acid neutralizing agent and heated until molten and homogenous. To this composition was added the solvent and methyl ester of rosin (plasticizer component) under continued heat. The varnish was then allowed to cool to room temperature. The varnish was added into a container holding the waterbased pigment dispersion and stirred. The wax was added to the mixture and stirred, followed separately by the thermoplastic latex emulsion and then the plasticizer component. The printing ink composition was mixed thoroughly.

The VOC content of the ink was about 18.6 wt. %.

### EXAMPLE 2

Using the printing ink of Example 1, prints were prepared on paper substrate (60 pound Mead paper) using a Prufbau Printability Tester. 300 mm³ volume was used to print at a speed of 7 m/s. The ink had the following properties as tested on a Tackmaster 92 (manufactured by Kershaw Instrumentation, Swedesboro, N.J.) at a speed of 1000 rpm:

| | |
|---|---|
| Tack at one minute | 14 gram-meters |
| Tack at 10 minutes | 26 gram-meters |

The Tackmaster 92 was cleaned with an aqueous surfactant cleaning solution (ZEP, available from ZEP Manufacturing). The Tackmaster cleaned easily and thoroughly.

The print was dried in an oven at a print temperature of about 260° F. The print had a density of 1.39 measured with an X-Rite Densitometer, manufactured by X-Rite of Grandville, MI. One drop of water was placed on the dried print for five minutes and no ink dissolved in the water.

The printing ink was waterwashable in a neutralized state and water-fast in the dry state. The printing ink had good tack, rheology and low VOC content.

### EXAMPLE 3

A water-washable lithographic printing ink was prepared from the components indicated below in Table 2.

TABLE 2

| | Weight |
|---|---|
| Component | Percentage |
| Waterbased pigment dispersion | 20.1 |
| (BCD-9444, 51% cyan pigment, Sun | |
| Chemical) | |
| Modified rosin resin (Unirez 8110, maleic | 26.8 |
| modified rosin ester, Arizona Chemical) | |
| Acid neutralizing agent | 6.7 |
| (N-methyldiethanolamine) | |
| Solvent (Hexylcarbitol, diethylene glycol | 16.4 |
| monohexyl ether, Union Carbide, 3.0%, | |
| and Neodol 23, C12/C13 alcohol blend, | |
| Shell, 13.4%) | |
| Plasticizer (Hercolyn D, methyl ester of | 20.0 |
| rosin, Hercules) | |
| Thermoplastic latex emulsion (JONCRYL | 10.0 |
| 89 styrenated acrylic polymer emulsion, | |
| Johnson Polymer) | |
| TOTAL | 100 |

A varnish was formulated by heating the modified rosin resin until molten. The acid neutralizing agent was added to the modified rosin resin and heated while stirring and until homogeneous. To this composition was added the solvent and plasticizer under continued heat and stirring. Once the varnish was homogeneous it was allowed to cool to room temperature. In a separate container, the thermoplastic latex emulsion was added to the waterbased pigment dispersion and stirred until homogeneous. The varnish was added to pigment latex mixture and stirred until mixed thoroughly.

The VOC content of the printing ink was about 23 weight %.

### EXAMPLE 4

Using the printing ink of Example 3, prints were prepared on paper substrate using a Prufbau Printability Tester. 350 mm³ volume was used to print at a speed of 2 m/s. The ink had the following properties as tested on a Tackmaster 92 (manufactured by Kershaw Instrumentation, Swedesboro, N.J.) at a speed of 1000 rpm:

| | |
|---|---|
| Tack at one minute | 23 gram-meters |
| Tack at 10 minutes | 32 gram-meters |

The Tackmaster 92 was cleaned with an aqueous surfactant cleaning solution (ZEP, available from ZEP Manufacturing). The Tackmaster cleaned easily and thoroughly.

The print was dried in an oven at a print temperature of about 280° F. The print had a density of 1.33-1.39. One drop of water was placed on the dried print for one minute and no printing ink dissolved in the water.

The printing ink was waterwashable in a neutralized state and water-fast in the dry state. The printing ink had good tack, rheology control and low VOC content.

### EXAMPLE 5

A water-washable lithographic printing ink was prepared from the components indicated below in Table 3.

TABLE 3

| | Weight |
|---|---|
| Component | Percentage |
| Waterbased pigment dispersion | 17.9 |
| (BCD-9444, 51% cyan pigment, | |
| Sun Chemical) | |
| Modified rosin resin (Unitac 70, | 22.4 |
| modified rosin, Arizona Chemical) | |
| Acid neutralizing agent | 8.3 |
| (N-methyldiethanolamine) | |
| Solvent (Neodol 23, C12/C13 | 4.5 |
| alcohol blend, Shell) | |
| Plasticizer (2-ethyl hexyl tallate, | 24.6 |
| Chemol) | |
| Thermoplastic latex emulsion | 20.1 |
| (JONCRYL 89, styrenated acrylic | |
| polymer emulsion, Johnson | |
| Polymer) | |
| Surfactant (Disperbyk 163, | 2.2 |
| polymeric dispersant, BYK | |
| Chemie) | |
| TOTAL | 100 |

A varnish was formulated by heating the modified rosin resin until molten. The acid neutralizing agent, solvent, plasticizer and surfactant were added to the modified rosin resin and heated while stirring. Once the varnish was homogeneous it was cooled to room temperature. In a separate container, the thermoplastic latex emulsion was added to the waterbased pigment dispersion and stirred until homogeneous. The varnish was added slowly and under continuous stirring to the pigment latex mixture and stirred until homogeneous.

The VOC content of the printing ink was about 14 weight %.

### EXAMPLE 6

Using the printing ink of Example 5, prints were prepared on paper substrate using Quick Peek handproofer (manufactured by Thwing-Albert, Philadelphia, Pa.). The printing ink had to the following properties as tested on a Tackmaster 92 (manufactured by Kershaw Instrumentation, Swedesboro, N.J.) at a speed of 1000 rpm:

| | |
|---|---|
| Tack at one minute | 18 gram-meters |
| Tack at 10 minutes | 18 gram-meters |

The Tackmaster 92 was cleaned with an aqueous surfactant cleaning solution (ZEP, available from ZEP Manufacturing). The handproofer was cleaned with tap water. Both cleaned easily and thoroughly.

The print was dried in an S&V oven at a paper temperature of about 280° F. The print had a density of between 1.23-1.35 as measured by an X-Rite densitometer, Grandville, Mich. One drop of water was placed on the dried print for one minute and no printing ink dissolved in the water.

The printing ink was waterwashable in a neutralized state and water-fast in the dry state. The printing ink had good tack, good rheology and low VOC content.

### EXAMPLE 7

A water-washable lithographic printing ink was prepared from the components indicated below in Table 4.

TABLE 4

| | Weight |
|---|---|
| Component | Percentage |
| Dry pigment (Sunfast ® Blue 15:3, | 10.2 |
| blue pigment, Sun Chemical) | |
| Modified rosin resin (RP-305, | 20.5 |
| phenolic modified rosin ester, | |
| Westvaco) | |
| Acid neutralizing agent | 7.7 |
| (N-methyldiethanolamine) | |
| Solvent (Neodol 23, C12/C13 | 10.3 |
| alcohol blend, Shell) | |
| Plasticizer (Hercolyn D, methyl | 25.6 |
| ester of rosin, Hercules, 15.4%, and | |
| 2-ethyl hexyl tallate, Chemol | |
| 10.2%) | |
| Thermoplastic latex emulsion | 25.7 |
| (JONCRYL 89, styrenated acrylic | |
| polymer emulsion, Johnson | |
| Polymer) | |
| TOTAL | 100 |

A varnish was formulated by combining the modified rosin resin with the acid neutralizing agent and heated until molten and homogenous. To this composition was added the solvent and one plasticizer (ethyl hexyl tallate) under continued heat and stirring. The varnish was then allowed to cool to room temperature. In a mill, the dry pigment was dispersed in the second plasticizer (methyl ester of rosin). The pigment mixture was added to the varnish while stirring. The thermoplastic latex emulsion was added to the mixture while stirring.

The VOC content of the printing ink was about 18 weight %.

### EXAMPLE 8

Using the printing ink of Example 7, prints were prepared on paper substrate using a Prufbau Printability Tester. 200 mm³ volume was used to print at a speed of 4 m/s. The printing ink had to the following properties as tested on a Tackmaster 92 (manufactured by Kershaw Instrumentation, Swedesboro, N.J.) at a speed of 1000 rpm:

| | |
|---|---|
| Tack at one minute | 15.9 gram-meters |
| Tack at 10 minutes | 17.2 gram-meters |

The Tackmaster 92 was cleaned with an aqueous surfactant cleaning solution (ZEP, available from ZEP Manufacturing). The Tackmaster cleaned easily and thoroughly.

The print was dried in an oven at a print temperature of about 290° F. The print had a density of about 1.25, measured on an X-Rite Densitometer. One drop of water was placed on the dried print for five minutes and no printing ink dissolved in the water.

The printing ink was waterwashable in a neutralized state and water-fast in the dry state. The printing ink had good tack, good rheology, and low VOC content.

### EXAMPLE 9

Three water-washable lithographic printing inks were prepared from the components indicated below in Table 5 according to the preparation method of Example 7, with the addition of the dispersant in Example 9B.

TABLE 5

| | Example | Example | Example |
|---|---|---|---|
| Component | 9A | 9B | 9C |
| Dry pigment (Sunfast ® Blue | 16.4 | 9.5 | 13.3 |
| 15:3, blue pigment, Sun Chemical) | | | |
| Modified rosin resin | 20.6^{(a)} | 22.3^{(f)} | 20.0^{(a)} |
| | | 3.2^{(g)} | |
| Acid neutralizing agent | 8.3 | 8.3 | 5.6 |
| (N-methyldiethanolamine) | | | |
| Solvent | 6.2^{(b)} | 9.5^{(c)} | 4.4^{(b)} |
| | 7.9^{(c)} | | 10.0^{(c)} |
| Plasticizer | 10.8^{(d)} | 5.6^{(d)} | 11.1^{(d)} |
| | 13.5^{(e)} | 18^{(e)} | 15.6^{(e)} |
| Thermoplastic latex emulsion | 12.5 | 22.2 | 16.7 |
| (JONCRYL 89, styrenated acrylic | | | |
| polymer emulsion, Johnson Polymer) | | | |
| Wax (micronized polyethylene) | 3.8 | 0 | 3.3 |
| Dispersant (Disperbyk 163, | 0 | 1.4 | 0 |
| BYK Chemie) | | | |
| TOTAL | 100 | 100 | 100 |

^{(a)}R891, manufactured by Resinall, a phenolic modified rosin ester.
^{(b)}Hexylcarbitol, manufactured by Union Carbide, a diethylene glycol monohexyl ether.
^{(c)}Neodol 23, manufactured by Shell, a C12/C13 alcohol blend.
^{(d)}Hercolyn D, manufactured by Hercules, a methyl ester of rosin.
^{(e)}2-ethyl hexyl tallate, manufactured by Chemol.
^{(f)}RP-305, manufactured by Westvaco, a phenolic modified rosin ester.
^{(g)}Unitac 70, manufactured by Arizona Chemical, a modified rosin.

The printing inks were waterwashable in a neutralized state and water-fast in the dry state. The printing inks had good tack, good rheology, and low VOC content.

### EXAMPLE 10

Two water-washable lithographic printing inks were prepared from the components indicated below in Table 6. Printing Ink example 10A was prepared according to the preparation method of Example 7 and Printing Ink Example 10B was prepared according to the preparation method of Example 1.

TABLE 6

| | Example | Example |
|---|---|---|
| Component | 10A | 10B |
| Waterbased pigment dispersion | 22.5 | 23.5 |
| (BCD-9444: 51% cyan pigment, Sun | | |
| Chemical) | | |
| Modified rosin resin (phenolic modified | 22.5^{(a)} | 17.7^{(e)} |
| rosin ester) | | |
| Acid neutralizing agent | 8.5 | 4.9 |
| (N-methyldietanolamine) | | |
| Solvent | 12.5^{(b)} | 8.8^{(b)} |
| | | 3.9^{(f)} |
| Plasticizer | 5.5^{(c)} | 9.8^{(c)} |
| | 24.5^{(d)} | 13.8^{(d)} |
| Thermoplastic latex emulsion (JONCRYL | 4.0 | 14.8 |
| 89, styrenated acrylic polymer emulsion, | | |
| Johnson Polymer) | | |
| Wax (micronized polyethylene) | 0 | 2.9 |
| TOTAL | 100 | 100 |

^{(a)}RP-305, manufactured by Westvaco.
^{(b)}Neodol 23, manufactured by Shell, C12/C13 alcohol blend.
^{(c)}Hercolyn D, manufactured by Hercules, methyl ester of rosin.
^{(d)}2-ethyl hexyl tallate, manufactured by Chemol.
^{(e)}R891, manufactured by Resinall.
^{(f)}Hexylcarbitol, manufactured by Union Carbide, diethylene glycol monohexyl ether.

The printing inks were waterwashable in a neutralized state and water-fast in the dry state. The printing inks had good tack, good rheology, and low VOC content.

### EXAMPLE 11

The printing inks of Example 10 were run on a Diddle Press using Rosos KSP 500 fountain solution and exhibited heatsetting at a speed of 1000 ft/min. and a web exit temperature of 300° F. The printing inks were then run on the same press using a waterless plate (no fountain solution) and exhibited heatsetting at a speed of 1000 ft./min. and a web exit temperature of 300° F.

Set off was comparable to conventional offset lithographic printing inks which typically use high VOC solvents.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A water-washable lithographic composition, the composition comprising:

| | |
|---|---|
| (a) | a rosin-based resin; |
| (b) | an alcohol solvent; |
| (c) | a pigment; |
| (d) | an acid neutralizing agent; |
| (e) | a plasticizer; and |
| (f) | a latex emulsion. |

2. The composition of claim 1 wherein the rosin-based resin has an acid number of about 20 to about 250.

3. The composition of claim 1 wherein the rosin-based resin is selected from the group consisting of phenolic-, maleic-, fumaric-, pentaerythritol-, hydrocarbon-, and/or mixtures of these groups.

4. The composition of claim 1 wherein the rosin-based resin is selected from the group consisting of dimerized and polymerized rosins, terpenes, rosin resins, rosin salts, tall oil resins, and mixtures thereof.

5. The composition of claim 1 wherein the rosin-based resin is about 0 wt. % to about 40 wt. %.

6. The composition of claim 5 wherein the rosin-based resin is about 10 wt. % to about 35 wt. %.

7. The composition of claim 6 wherein the rosin-based resin is present is about 15 wt. % to about 25 wt. %.

8. The composition of claim 1 wherein the alcohol solvent is selected from the group consisting of ethanols, propanols, butanols, pentanols, hexanols, octanols, nonanols, decanols, undecanols, dodecanols, tridecanols, glycols, and glycolethers.

9. The composition of claim 1 wherein the alcohol solvent is about 0 wt. % to about 35 wt. %.

10. The composition of claim 1, wherein the pigment is selected from the group consisting of presscake, dry pigment, dyes, flushes, pigment dispersions, and combinations thereof.

11. The composition of claim 1 wherein the amount of pigment present is in the range of about 1 parts pigment by weight to about 8 parts rosin-based resin by weight to about 1 parts pigment by weight to about 1 parts rosin-based resin by weight (about 1:8 to about 1:1) based on total weight of the composition.

12. The composition of claim 1 wherein the acid neutralizing agent is selected from the group consisting of primary amines, secondary amines, and tertiary amines.

13. The composition of claim 12 wherein the amine is selected from the group consisting of monoethanolamines, diethanolamines, dimethylethanolamine, methyldiethanolamine, triethanolamine, N-dimethylhexylamine, polyethylene imines, propylene diamines, hexamethylene diamines, dibutyl amines, diethylene triamines, and mixtures thereof.

14. The composition of claim 1 wherein the acid neutralizing agent is about 5 wt. % to about 15 wt. %.

15. The composition of claim 1 wherein the plasticizer is selected from the group consisting of tallate esters, phthallate esters, rosin esters, alkyds, polyesters, fatty acid esters, and mixtures thereof.

16. The composition of claim 1 wherein the plasticizer is about 0 wt. % to about 40 wt. %.

17. The composition of claim 1 wherein the thermoplastic latex emulsion is selected from the group consisting of modified acrylics, modified methacrylics, modified styrene, modified vinyls, modified styreneacrylics, and mixtures thereof.

18. The composition of claim 1 wherein the thermoplastic latex emulsion is about 0 wt. % to about 40 wt. %.

19. A dry lithographic printing ink comprising the composition of claim 1.

20. A wet lithographic printing ink comprising the composition of claim 1.
